(19) United States
(12) Patent Application Publication
(10) Pub. No.: US 2014/0102210 A1
(43) Pub. Date: Apr. 17, 2014

(54) Pressure Sensor With Robustness Against Mounting Stress

(71) Applicant: CONTINENTAL AUTOMOTIVE SYSTEMS, INC., Auburn Hills, MI (US)

(72) Inventors: Yanling Kang, Northbrook, IL (US); David Ivaska, Chicago, IL (US); Robert C. Kosberg, Wildwood, IL (US); Daniel J. Bratek, Palatine, IL (US)

(73) Assignee: CONTINENTAL AUTOMOTIVE SYSTEMS, INC., Auburn Hills, MI (US)

(21) Appl. No.: 13/649,183

(22) Filed: Oct. 11, 2012

(51) Int. Cl. G01L 7/00; B23K 31/02

(52) U.S. Cl. 73/756; 228/178

(57) ABSTRACT

A pressure sensor includes a metal port member having a first closed end and a second opposing opened end. A metal shell surrounds a portion of the periphery of the port. A first weld connection joins the port to the shell. A metal base has upper and lower surfaces and a second weld connection joins the shell to the lower surface of the base. Sensing structure is associated with the closed end of the port member. The sensing structure is constructed and arranged to sense pressure changes at the closed end of the port member. A connector housing covers the sensing structure.

### FIELD

This invention relates to pressure sensors for high pressure gasoline or diesel direct injection or braking systems and, more particularly, to a pressure sensor that employs welding to combine lower-cost individual parts so as to reduce the overall cost of the pressure sensor.

### BACKGROUND

With reference to FIG. 1, a cross-sectional view of a pressure sensor as disclosed in U.S. Pat. No. 6,813,953 is shown, generally indicated at 10. A port assembly, generally indicated at 11, has a two-piece configuration including a port or stem 12 and a surrounding threaded housing 13. Such a complicated configuration is difficult to machine, is wasteful of raw materials, and is of high cost. This sensor is also of large size, particularly in height.

Thus, there is a need to provide pressure sensor that has s simpler geometry, is easier to fabricate, uses less raw materials, and costs less than conventional sensors.

### SUMMARY

An objective of the invention is to fulfill the need referred to above. In accordance with the principles of an embodiment, this objective is achieved by a pressure sensor that includes a metal port member having a first closed end and a second opposing opened end. A metal shell surrounds a portion of the periphery of the port. A first weld connection joins the port to the shell. A metal base has upper and lower surfaces and a second weld connection joins the shell to the lower surface of the base. Sensing structure is associated with the closed end of the port member. The sensing structure is constructed and arranged to sense pressure changes at the closed end of the port member. A connector housing covers the sensing structure.

In accordance with another aspect of an embodiment, a method of joining portions of a pressure sensor is provided. The pressure sensor has a metal port member having a first closed end and a second, opposing opened end; a metal shell surrounding a portion of the periphery of the port; a metal base having upper and lower surfaces; and sensing structure associated with the closed end of the port member. The sensing structure is constructed and arranged to sense pressure changes at the closed end of the port member. The method includes the steps of welding the port member to the shell and welding the shell to the lower surface of the base.

Other objectives, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a cross-sectional view of a prior art pressure sensor having a two-piece port assembly.

FIG. 2 is a cross-section view of a pressure sensor provided in accordance with an embodiment, having a four-piece port assembly.

FIG. 3 is a cross-section of pressure sensor provided in accordance with another embodiment.

### DETAILED DESCRIPTION OF EXEMPLARY EMBODIMENTS

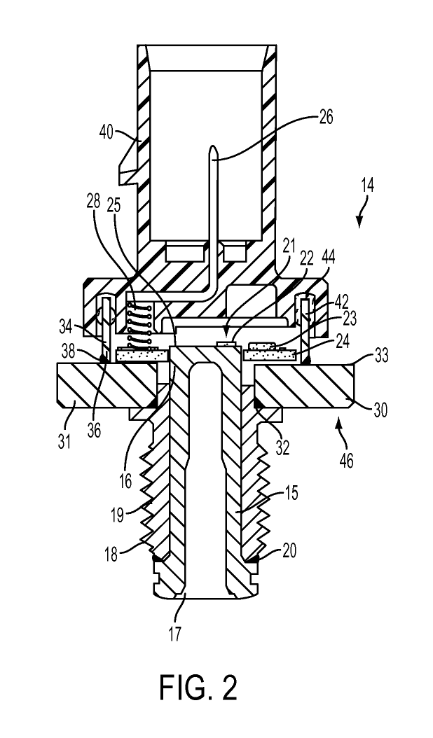

FIG. 2 shows a high pressure sensor, generally indicated at 14, preferably for use in high pressure gasoline or diesel direct injection or braking systems, or other similar systems. The sensor 14 includes a metal port member 15, preferably in the form of a hollow cylinder having a first closed end 16 and a second, opposing opened end 17. A metal shell 18 surrounds a portion of the periphery of the port member 15. The shell 18 includes external threads 19 for mounting the sensor 14. A first weld connection 20 joins the port member 15 and the shell 18 about their peripheries near end 17 of the port member 15. Pressure to be measured is transmitted to the closed end 16 of the port member 15 through the opened end 17.

Sensing structure, generally indicated at 21, is associated with the closed end 16 of the port member 15 to sense pressure changes at closed end 16. In the embodiment, the sensing structure 21 includes a sensor element 22 mounted to the outer surface of the closed end 16 and a substrate 24 defining a circuit board that is electrically connected to the sensor element 22 by wire bonding in the conventional manner. The substrate 24 is preferably a PCB substrate having an application specific integrated circuit (ASIC) 23 thereon for processing and conditioning signals from the sensor element 22. The sensor element 22 is can be a semiconductor sensing device including strain gauges (not shown) that strain synchronously to change an electrical characteristic of the gauges when the closed end 16 strains due to the pressure to be measured. The sensor element 22 is preferably glass bonded on the outer surface 25 of the closed end 16 of the port member 15. The substrate 24 is electrically connected to terminals 26 via a metal springs 28, preferably coil springs. Only one spring 28 and associated terminal 26 is shown in FIG. 2. Signals processed by the substrate 24 are transmitted to an outside circuit through the springs 28 and terminals 26. The springs 28 and terminals 26 can be considered to be part of the sensing structure 21.

A metal base 30, preferably having a hexagonal shaped periphery for engagement by a tool, is joined at a bottom surface 31 thereof to the metal shell 18 by a second weld connection 32. A hollow metal tube structure 34 is joined at one end 36 to a top surface 33 of the base 30 by a third weld connection 38. The sensing structure 21 is preferably encapsulated and disposed within the tube structure 34. A connector housing 40, preferably of resin, is connected to a second end 42 of the tube structure 34, preferably by a tongue and groove seal connection 44. The connector housing 40 covers the sensing structure 21. The first, second and third weld connections can be achieved by laser or other welding techniques. The weld connections are preferred, but fasteners, adhesives or other similar joining methods can be used instead.

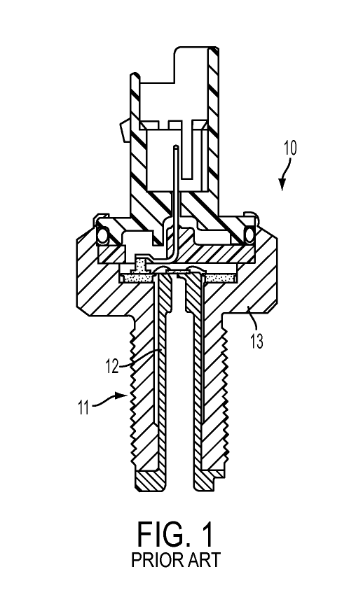

The port member 15, shell 18, base 30 and tube structure 34 comprise a four-piece port assembly, generally indicated at 46, having a simpler geometry than conventional sensors and thus is easier to manufacture. The pressure sensor 14 reduces the use of raw materials and is of lower cost than the sensor of the type shown in FIG. 1. The pressure sensor 14 is robust against mounting stresses and has a reduce height as compared to conventional industrial pressure sensor configurations.

The sequence of the assembly of the pressure sensor 14 can be performed in many ways since there is less constraint compared to the assembly of the pressure sensor of FIG. 1. For example, the pressure sensor 14 allows the first and second weld connections 20 and 32, to be made before glass printing of the sensing element 22 on the port 15, and subsequent wire-bonding. This arrangement is advantageous since numerous particles are generated during the welding process that could contaminate unprotected sensing elements, ASIC and wire-bonding.

With the pressure sensor 14, final welding between the base 30 and the tube structure 34 can be done when circuit is already encapsulated and protected. In the conventional two-piece pot assembly, welding the two pieces has to be done before wire-bonding, therefore exposing the bare die during welding.

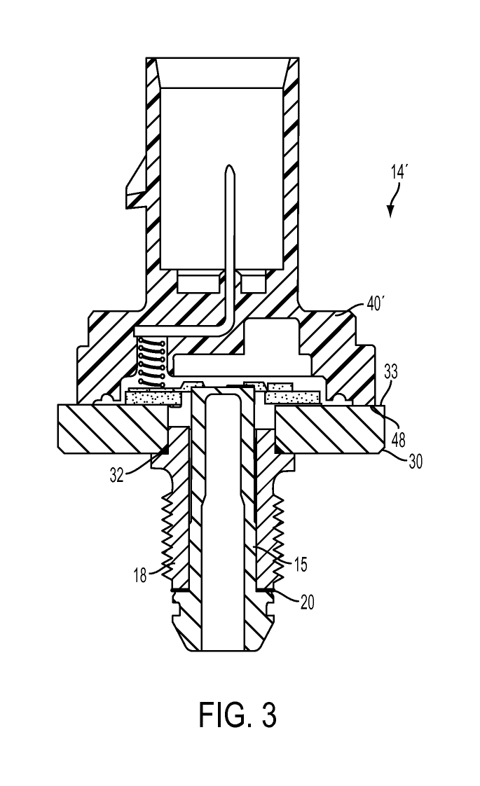

FIG. 3 shows another embodiment of the pressure sensor, generally indicated at 14′. Instead of providing the tube structure 34 as in FIG. 2, the connector housing 40′ is coupled directly to surface 33 of the base 30 by adhesive such as, for example, high-strength silicone adhesive. This structure also eliminates weld 38 of FIG. 2.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

What is claimed is:

1. A pressure sensor comprising:
a metal port member having a first closed end and a second opposing opened end,
a metal shell surrounding a portion of the periphery of the port,
a first weld connection joining the port to the shell,
a metal base having upper and lower surfaces,
a second weld connection joining the shell to the lower surface of the base,
sensing structure associated with the closed end of the port member, the sensing structure being constructed and arranged to sense pressure changes at the closed end of the port member, and
a connector housing covering the sensing structure.

2. The pressure sensor of claim 1, wherein the shell includes external threads.

3. The pressure sensor of claim 1, wherein a periphery of the base is of hexagonal shape.

4. The pressure sensor of claim 1, wherein the sensing structure includes a sensor element mounted to the closed end of the port member constructed and arranged to detect strains of the closed end, a substrate electrically connected to the sensor element, terminals, and a spring electrically connecting the substrate with an associated terminal.

5. The pressure sensor of claim 4, wherein the sensing structure includes an ASIC on the substrate.

6. The pressure sensor of claim 4, wherein the springs are coil springs.

7. The pressure sensor of claim 1, wherein a portion of the connector housing is joined with the base.

8. The pressure sensor of claim 1, further comprising:
a metal tube structure having first and second ends, and
a third weld connection joining the first end of the tube structure to the upper surface of the base,
wherein the sensing structure is disposed within the tube structure and the connector housing is connected to the second end of the tube structure.

9. The pressure sensor of claim 8, wherein the connection between the connector housing and the tube structure is a sealed connection.

10. A pressure sensor comprising:
a metal port member having a first closed end and a second, opposing opened end,
a metal shell surrounding a portion of the periphery of the port,
first means for joining the port to the shell,
a metal base,
second means for joining the shell to the base,
means, associated with the closed end of the port member, for sensing pressure changes at the closed end of the port member, and
a connector housing covering the means for sensing.

11. The pressure sensor of claim 10, wherein the shell includes external threads.

12. The pressure sensor of claim 10, wherein a periphery of the base is of hexagonal shape.

13. The pressure sensor of claim 10, wherein the means for sensing includes a sensor element mounted to the closed end of the port member to detect strains of the closed end, a substrate electrically connected to the means for detecting, terminals, and means for electrically connecting the substrate with an associated terminal.

14. The pressure sensor of claim 13, wherein the sensing structure includes an ASIC on the substrate.

15. The pressure sensor of claim 13, wherein the means for electrically connecting is a coil spring.

16. The pressure sensor of claim 10, wherein a portion of the connector housing is joined with the base.

17. The pressure sensor of claim 10, further comprising:
a metal tube structure having first and second ends, and
third means for joining the first end of the tube structure to the upper surface of the base,
wherein the means for sensing is disposed within the tube structure and the connector housing is connected to the second end of the tube structure.

18. The pressure sensor of claim 10, wherein the connection between the connector housing and the tube structure is a sealed connection.

19. The pressure sensor or claim 10, wherein each of the first, second and third means for joining is a weld connection.

20. A method of joining portions of a pressure sensor, the pressure sensor having a metal port member having a first closed end and a second, opposing opened end; a metal shell surrounding a portion of the periphery of the port; a metal base having upper and lower surfaces; and sensing structure associated with the closed end of the port member, the sensing structure being constructed and arranged to sense pressure changes at the closed end of the port member, the method comprising the steps of:
welding the port to the shell, and
welding the shell to the lower surface of the base.
